(19) United States
(12) Patent Application Publication
(10) Pub. No.: US 2016/0219890 A1
(43) Pub. Date: Aug. 4, 2016

(54) OMASUM WASHING MACHINE

(71) Applicant: MATOYA TECHNICAL SYSTEM ENGINEERING INDUSTRY CO., LTD., Kagoshima (JP)

(72) Inventor: Hukuichi MASUDOME, Soo-city (JP)

(21) Appl. No.: 14/424,128

(22) PCT Filed: Sep. 24, 2014
(86) PCT No.: PCT/JP2014/075244

§ 371 Date: Feb. 26, 2015

(30) Foreign Application Priority Data
Oct. 22, 2013 (JP) 2013-219034

(51) Int. Cl. A22B 5/18; A22C 17/08

(52) U.S. Cl. CPC A22B 5/18; A22C 17/08; A23L 1/312; A23V 2002/00

(57) ABSTRACT

An omasum washing machine eliminates use of a motor shaft requiring a forward/backward rotation switching operation which can damage the motor shaft and prevents washing water from splashing to the outside of a tank. This is accomplished by providing inner and outer stirrers, the inner stirrer and the outer stirrer being coupled with a forward rotating drive motor and a backward rotating drive motor, respectively.

### BACKGROUND OF THE INVENTION

The present invention relates to an omasum washing machine which can, in a remarkably short time, wash dirt of food refuse or the like contained and deposited in an edible meat region of a cow omasum (the third stomach and the fourth stomach) or the like in which thin folds overlap with one another.

Heretofore, in the case of washing of omasa, a small amount of omasa have manually been washed in a water tank, and a large amount of omasa have been washed by using a washing machine of a rotary basket system. An example of the machine is a device which rotates a bottom plate of a drum type washing tank to perform washing (see Jpn. Pat. Appln. Publication No. H07-205360). However, in this device, the fact is that dirt in folds can hardly be washed and further, an operator manually washes the dirt while opening the folds. To solve the problem, for example, there has been suggested a device in which a strong and high-speed water current is generated by stirring blades in a cylindrical water tank, a leaf opening operation of the folds is caused by inverted stirring for several seconds, and the dirt in the folds of the omasa is completely washed by a baffle plate for the water current and air stirring from an air outlet (see Jpn. Pat. Appln. Publication No. 2005-168325).

### SUMMARY OF THE INVENTION

However, in this washing device, an expensive servo motor is used to perform an operation of repeating a forward rotation and a backward rotation of the same stirring blade, and the forward/backward rotation is momentarily switched, so that an excessive load is applied to a motor shaft, and a key portion which fastens a rotary shaft of the motor to a pulley is easily damaged, thereby causing the problem that not only the device needs to be frequently repaired but also a life of the motor itself is short. In addition, for a similar reason, there has been a hygienic problem that due to an urging force during the backward direction, washing water hits a convex plate of an inner surface wall of a water tank to highly splash and scatter to the outside of the tank, thereby causing damage to a control device, covering an operator or making a periphery dirty.

To solve the problems, the present inventors have intensively made studies to further improve a washing effect of a drum type washing machine, and have developed the present invention to shorten an operation time. An object of the present invention is to provide an omasum washing machine which can eliminate damages of a motor shaft in a forward/backward rotation switching operation and can prevent washing water from being flied and scattered to the outside of a tank.

In consequence, according to the present invention, a drum type omasum washing machine, comprising a forward/backward rotatable stirrer in a washing tank having an opened upper surface, has first characteristics that the stirrer comprises at least two sets of stirring blades including a set of inner stirring blades and a set of outer stirring blades and having different rotation radiuses, at least one of the sets of stirring blades is attached to a hollow shaft tube to be rotatably supported in a bearing housing of the washing tank, a rotary shaft of the other set of stirring blades is inserted into the hollow shaft tube and rotatably supported by a bearing disposed in the hollow shaft tube, and each of the inner and outer sets of stirring blades is coupled with a driving device to be rotatable alone. Additionally, in the second characteristics, the inner stirring blade set and the outer stirring blade set are simultaneously or alternately rotated in directions opposite to each other to generate an inversion stirring water current, and fold portions of an omasum are forcibly opened. Furthermore, in the third characteristics, dirt sedimented in the washing tank is discharged via a filtering screen and scum floated in the washing tank is discharged from an overflow port, continuously to the outside of the tank. Furthermore, in the fourth characteristics, the inner stirring blade set and the outer stirring blade set alternately rotate in the directions opposite to each other. Additionally, in the fifth characteristics, the inner stirring blade set and the outer stirring blade set simultaneously rotate in the directions opposite to each other.

### BRIEF DESCRIPTION OF THE DRAWINGS

FIG. 1 is a plan view showing an omasum washing machine according to the present invention; and

FIG. 2 is a vertical sectional view of the omasum washing machine according to the present invention.

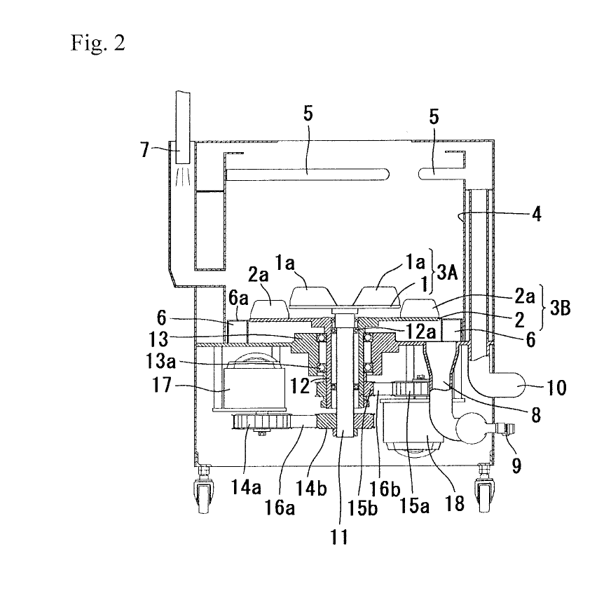

### DETAILED DESCRIPTION OF THE INVENTION

Hereinafter, one embodiment of a washing machine of the present invention will be described with reference to the drawings.

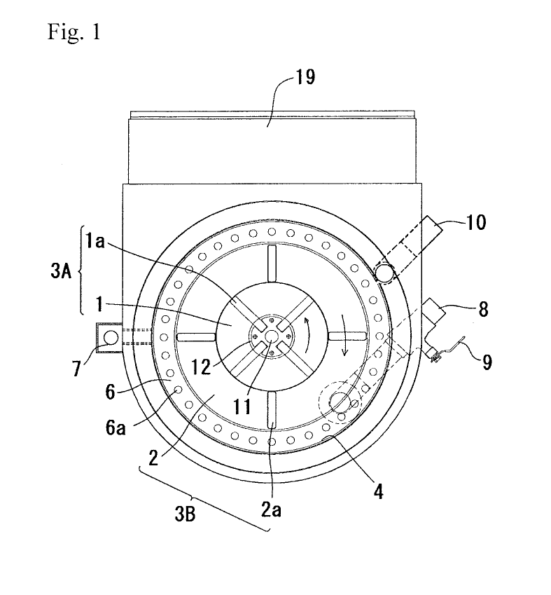

As shown in FIG. 1 and FIG, 2, an omasum washing machine concerned with the present invention comprises a first stirrer 3A and a second stirrer 3B having different sizes of outer diameters in an inner bottom portion of a drum type washing tank 4 having an opened upper surface. The first stirrer 3A disposed outside is constituted by vertically disposing a plurality of stirring blades 2a on a rotary disc 2, and a hollow shaft tube 12 is formed integrally from a lower end of a center of the stirrer and rotatably supported by a bearing 13a of a housing 1 of the washing tank 4.

On the other hand, the second stirrer 3B is constituted by vertically disposing a plurality of stirring blades 1a on a rotary plate 1, and a rotary shaft 11 of the stirrer is inserted into the hollow shaft tube 12 and rotatably supported by a bearing 12a disposed in the hollow shaft tube 12. The inner and outer stirrers, i.e., the first stirrer 3A and the second stirrer 3B are coupled with a forward rotating drive motor 17 and a backward rotating drive motor 18, respectively, so that each of the stirrers is rotatable alone.

Here, in the first drive motor 17 and the rotary shaft 11, an inner shaft drive pulley 14a is coupled with an inner shaft driven pulley 14b via a drive belt 16a, and in the second drive motor 18 and the hollow shaft tube 12, an inner shaft drive pulley 15a is coupled with an inner shaft driven pulley 15b via a drive belt 16b. Furthermore, a control device 19 arbitrarily sets rotation numbers, and the stirrers are rotated in directions opposite to each other. For example, as shown by arrows in FIG. 1, the stirrers rotate clockwise and counterclockwise. Consequently, a strong and high-speed inversion stirring water current is generated in the washing tank 4, and a large number of fold portions present in an omasum are opened by a stirring operation of the water current, so that dirt in folds can effectively be discharged.

This high-speed inversion stirring water current always becomes a constant stirring water current, and as compared with a conventional washing machine which performs a forward rotating/backward rotating operation, splashes of water in the washing tank 4 extremely decrease. Furthermore, the water currents generated in the directions opposite to each other in the washing tank 4 are entangled with each other to make a complicated water current, the dirt in the folds of the omasum is securely separated, and a heavy solid material sedimented in the washing tank 4 passes a filtering screen 6 to be discharged to the outside of the washing tank 4. Furthermore, floated scum is continuously discharged to the outside of the washing tank 4 from overflow ports 5, and hence the omasum can efficiently be washed in a short time.

The dirt in the opened folds makes washing water dirty, and hence the water is continuously discharged through an overflow discharge tube 10 from the overflow ports 5 in an upper portion of the washing tank 4 while newly supplying clean water from a supply water port 7.

In addition, the heavy solid material sedimented in the washing tank 4 drops down from an opening 6a of the circular filtering screen 6 disposed in an outer periphery of the outer rotary plate 2, and is discharged to the outside of the washing tank 4 by opening a dirty water discharge valve 9 coupled with a dirt discharge tube 8.

As described above, in the omasum washing machine of the present invention, unlike a conventional device, the same stirring blade set is not rotated forward and backward, but each of so-called inner stirring blade set and outer stirring blade set only shares a rotation in one of directions of a forward rotation and a backward direction. In addition, these blades can be used by simultaneously rotating the blades, or alternately rotating the respective blades in one direction, so that an operator can selectively use the blades. It is to be noted that two drive motors are not necessarily required, and one drive motor can rotate each stirring blade set forward or backward by use of a year and the like.

According to a device of the present invention, the following advantageous effects are produced.

(1) A motor shaft is not damaged, an expensive servo motor does not have to be used, an inexpensive induction motor is usable, and hence the device can be prepared at low cost.

(2) A controller also only has a simple constitution in which a rotation number is set by an inverter.

(3) A water level of washing water slightly rises or lowers, but the water does not highly fly or splash, which eliminates the problem that the water flies and scatters to the outside of a washing tank to break a control device or to make an operator or a periphery dirty.

1. A drum type omasum washing machine comprising a forward/backward rotatable stirrer in a washing tank having an opened upper surface,
wherein the stirrer comprises at least two sets of stirring blades including a set of inner stirring blades and a set of outer stirring blades and having different rotation radiuses,
at least one of the sets of stirring blades is attached to a hollow shaft tube to be rotatably supported in a bearing housing of the washing tank, a rotary shaft of the other set of stirring blades is inserted into the hollow shaft tube and rotatably supported by a bearing disposed in the hollow shaft tube, and each of the inner and outer set of stirring blades is coupled with a drive motor to be rotatable alone.

2. The omasum washing machine according to claim 1
wherein the set of inner stirring blades and the set of outer stirring blades are simultaneously or alternately rotated in directions opposite to each other to generate an inversion stirring water current, and fold portions of an omasum are forcibly opened.

3. The omasum washing machine according to claim 1,
wherein dirt sedimented in the washing tank is discharged via a filtering screen and scum floated in the washing tank is discharged from an overflow port, continuously to the outside of the tank.

4. The omasum washing machine according to claim 1,
wherein the set of inner stirring blades and the set of outer stirring blades alternately rotate in directions opposite to each other.

5. The omasum washing machine according to claim 1,
wherein the set of inner stirring blades and the set of outer stirring blades simultaneously rotate in directions opposite to each other.
